(19) United States
(12) Patent Application Publication
(10) Pub. No.: US 2025/0000621 A1
(43) Pub. Date: Jan. 2, 2025

(54) TECHNIQUES FOR MOLAR DISTALIZATION

(71) Applicant: LightForce Orthodontics, Inc., Burlington, MA (US)

(72) Inventor: Oisin Duggan, Somerville, MA (US)

(73) Assignee: LightForce Orthodontics, Inc., Burlington, MA (US)

(21) Appl. No.: 18/756,126

(22) Filed: Jun. 27, 2024

Related U.S. Application Data
(60) Provisional application No. 63/511,014, filed on Jun. 29, 2023.

(51) Int. Cl. A61C 7/18; A61C 7/14

(52) U.S. Cl. CPC A61C 7/18; A61C 7/146

(57) ABSTRACT

The techniques provide for a dental appliance, a method for treating a patient with the dental appliance, and a method of manufacturing the dental appliance. The dental appliance includes a bar with a first end and a second end. The first end is configured to engage with a first tooth. The dental appliance also includes a coupling portion at the end of the bar configured to engage with an orthodontic bracket bonded to a second tooth. The coupling portion is configured to rotate about an axis.

### CROSS-REFERENCE TO RELATED APPLICATION

This patent application claims priority under 35 U.S.C. § 119 (e) to U.S. Provisional Patent Application No. 63/511,014, titled “TECHNIQUES FOR MOLAR DISTALIZATION,” filed Jun. 29, 2023, which is hereby incorporated by reference in its entirety.

### BACKGROUND

Orthodontics has been widely adapted in clinics to correct various types of malocclusions (e.g., crowded teeth, crooked, etc.) by applying controlled forces to the teeth. To straighten teeth, orthodontic brackets are adhered onto the patient's teeth, and an arch wire (e.g., elastic metal wires of round, square, or rectangular cross-sectional shape) is run through the bracket slots and secured to the brackets (e.g., via elastics) to provide the driving force to straighten the teeth. The adaptation of each bracket to an associated individual tooth is performed by filling the gap between the tooth surface and bracket surface with adhesive. The bracket is bonded to the tooth such that the bracket slot, when the teeth are moved to their final position, lies in a near flat (depending on manufacturing accuracy) horizontal plane that is achieved through the arch wire.

To create space in the dental arch, distalization devices may be used. Some distalization devices include a bar that spans the distance between two teeth. The bar is bonded to the individual teeth by filling the gap between the tooth surface and the bar with an adhesive. Once, the bar is bonded to the teeth, the bar may apply forces to the teeth to move one or more teeth for creating more space in the dental arch.

### SUMMARY OF THE INVENTION

The present disclosure relates to a dental appliance that includes a bar comprising a first end and a second end, wherein the first end is configured to engage with a first tooth and a coupling portion at the second end of the bar configured to engage with an orthodontic bracket bonded to a second tooth, wherein the coupling portion is configured to rotate about an axis and the first end is configured to engage with the first tooth by engaging with a second bracket bonded to the first tooth.

The present disclosure also relates to a dental appliance wherein the coupling portion comprises a flexible portion configured to rotate about the axis and the coupling portion comprises a mating connection configured to connect to a bracket attachment that engages with the orthodontic bracket bonded to the second tooth. The orthodontic bracket is a tube with an inlet configured to receive an end of an arch wire and the bracket attachment comprises a protrusion that fits within the inlet to engage the bracket attachment with the orthodontic bracket.

The present disclosure also relates to a dental appliance wherein the bar is a distalizer. The second tooth comprises a molar and the bar is configured to distalize the molar. The first end of the bar comprises an engagement feature configured to engage with an elastic element and the elastic element applies a distal force on the bar. The first end of the elastic element is configured to engage with the engagement feature and a second end of the engagement feature is configured to engage with a third orthodontic bracket attached to a mandibular tooth.

The present disclosure also relates to a dental appliance wherein the coupling portion is configured to rotate about the occluso-gingival axis and the first tooth is one of a canine and a premolar.

The present disclosure also relates to a method of treating a patient using a dental appliance, comprising installing the dental appliance, wherein the dental appliance comprises a bar comprising a first end and a second end, wherein the first end is configured to engage with a first tooth; and a coupling portion at the second end of the bar configured to engage with an orthodontic bracket bonded to a second tooth, wherein the coupling portion is configured to rotate about an axis.

The present disclosure also relates to a method of treating a patient using a dental appliance wherein installing comprises engaging the first end with the first tooth and engaging the coupling portion with the orthodontic bracket bonded to the second tooth. The coupling portion comprises a mating connection configured to connect to a bracket attachment that engages with the orthodontic bracket bonded to the second tooth. The first end of the bar comprises an engagement feature configured to engage with an elastic element and the elastic element applies a distal force on the bar. The coupling portion is configured to rotate about the occluso-gingival axis.

The present disclosure also relates to a method of manufacturing a dental appliance, comprising manufacturing the dental appliance, wherein the dental appliance comprises a bar comprising a first end and a second end, wherein the first end is configured to engage with a first tooth; and a coupling portion at the second end of the bar configured to engage with an orthodontic bracket bonded to a second tooth, wherein the coupling portion is configured to rotate about an axis. The coupling portion comprises a mating connection configured to connect to a bracket attachment that engages with the orthodontic bracket bonded to the second tooth. The first end of the bar comprises an engagement feature configured to engage with an elastic element and the elastic element applies a distal force on the bar and the coupling portion is configured to rotate about the occluso-gingival axis.

The present disclosure also relates to a dental appliance, comprising a sheath through hole, wherein the through hole is configured to receive an arch wire, the sheath is configured to transmit a distal force from a first orthodontic appliance to a second orthodontic appliance, and the first orthodontic appliance is adjacent to the second orthodontic appliance. The length of the sheath is approximately a length of a gap between the first orthodontic appliance and the second orthodontic appliance and the first orthodontic appliance and the second orthodontic appliance are orthodontic brackets. The first orthodontic appliance includes a hook, the hook is configured to suspend an elastic element, and the suspension of the elastic element causes a distal force to be applied on to the first orthodontic appliance.

The present disclosure also relates to a dental appliance comprising a wire configured to engage with a first orthodontic appliance attached to a first tooth, engage with a second orthodontic appliance attached to a second tooth, and transmit a distal force from the first orthodontic appliance to the second orthodontic appliance. The wire comprises a flexible section disposed between the first and second orthodontic appliances. The flexible section is configured to convert the distal force to a rotational force, such that the rotational force rotates the second tooth about the occluso-gingival axis and the first and second orthodontic appliances are brackets.

### BRIEF DESCRIPTION OF THE DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 shows a process diagram of a method of treating a malocclusion using a distalization system according to aspects of the present disclosure.

FIG. 2 shows a plan view of an exemplary distalization system according to aspects of the present disclosure.

FIG. 3A shows a perspective view of the distalization system of FIG. 2 according to aspects of the present disclosure.

FIG. 3B shows a side view of the distalization system of FIG. 2 according to aspects of the present disclosure.

FIG. 4A shows a perspective view of the distalization system of FIG. 2 placed within a patient's mouth according to aspects of the present disclosure.

FIG. 4B shows a plan view of the distalization system of FIG. 2 placed within a patient's mouth according to aspects of the present disclosure.

FIG. 5A shows a side view of another exemplary distalization system placed within a patient's mouth according to aspects of the present disclosure.

FIG. 5B shows a top view of the distalization system of FIG. 5A placed within a patient's mouth according to aspects of the present disclosure.

FIG. 5C shows a side view of a third exemplary distalization system placed within a patient's mouth according to aspects of the present disclosure.

FIG. 5D shows a perspective view of the third exemplary distalization system of FIG. 5C according to aspects of the present disclosure.

FIG. 6A shows a side view of a fourth exemplary distalization system placed within a patient's mouth according to aspects of the present disclosure.

FIG. 6B shows a perspective view of sheath of the fourth exemplary distalization system of FIG. 6A according to aspects of the present disclosure.

FIG. 7A shows a side view of a fifth exemplary distalization system placed within a patient's mouth according to aspects of the present disclosure.

FIG. 7B shows a perspective view of the passive wire of the fifth exemplary distalization system of FIG. 7A according to aspects of the present disclosure.

### DETAILED DESCRIPTION OF THE INVENTION

The present disclosure relates to techniques for distalizing a patient's teeth. Distalization may include the movement of at least one tooth to increase the space of the dental arch. In some instances, a patient may require both orthodontic brackets/tubes and a distalization device to correct the malocclusion. In such instances, given the limited space available on a patient's teeth for bonding orthodontic devices, conventional techniques require using a distalization device separately from other orthodontic devices (e.g., orthodontic tube(s), brace(s), and/or arch wire(s)). Thus, for example, prior to the use of orthodontic brackets (e.g., to straighten the patient's teeth), a patient may first be treated with a distalization device to create space in the dental arch. Accordingly, a first patient visit (and possibly one or more subsequent visits) is required to bond the distalization device to the patient's teeth and to use the distalization device to obtain the desired spacing. After distalization, the patient must then make a second visit (and possibly additional visits) to remove the distalization device from the teeth and to then bond the orthodontic brackets/tubes onto the patients teeth to straighten the teeth. The inventors have appreciated that such bonding and removal of the distalization device, which must be done separately from subsequent use of brackets for the patient, can result in various issues, including increasing the time and/or cost of the treatment, and/or negatively impacting the patient's experience.

The inventors have appreciated that it can be desirable for a distalization device to engage with other orthodontic appliances, rather than needing to be separately bonded to the patient's teeth. In particular, the inventors have appreciated that providing for distalization devices that can interact with other orthodontic appliances, such as orthodontic brackets and/or orthodontic tubes, may case the patient's transition from the distalization treatment to another treatment utilizing other orthodontic appliances. The inventors have further appreciated that it can be desirable for a distalization device to engage with other orthodontic appliances (e.g., orthodontic brackets and/or tubes with an arch wire) such that a distalization treatment may be performed concurrently with another orthodontic treatment method. Such approaches can significantly speed up the treatment time, reduce the number of orthodontic office visits required for a patient, reduce cost, and/or improve the patient's overall experience with the orthodontic treatments.

In some embodiments, distalization devices or systems are configured to engage with orthodontic appliances (e.g., brackets or tubes) as described in detail according to the techniques described herein. For the purposes of promoting an understanding of the principles of the present disclosure, reference will now be made to the embodiments illustrated in the drawings, and specific language will be used to describe the same. It will nevertheless be understood that no limitation of the scope of the invention is thereby intended.

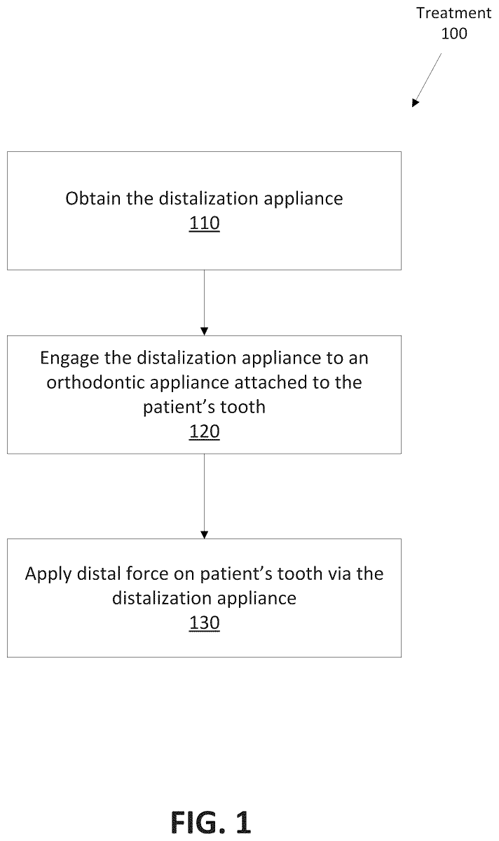

FIG. 1 shows a method 100 of treating a malocclusion using a distalization system according to aspects of the present disclosure. Treatment may begin a block 110 by obtaining the distalization appliance. Treatment may continue to block 120 in which the distalization appliance engages with an existing orthodontic appliance that is attached to a patient's tooth. As such, the distalization appliance can be used in conjunction with the orthodontic appliance. At block 130, a distal force is applied to a patient's tooth or teeth via the distalization appliance. The distal force may move the patient's tooth or teeth distally such that the dental arch is increased. In some embodiments, the distal force may rotate a patient's tooth or teeth such that the dental arch is increased.

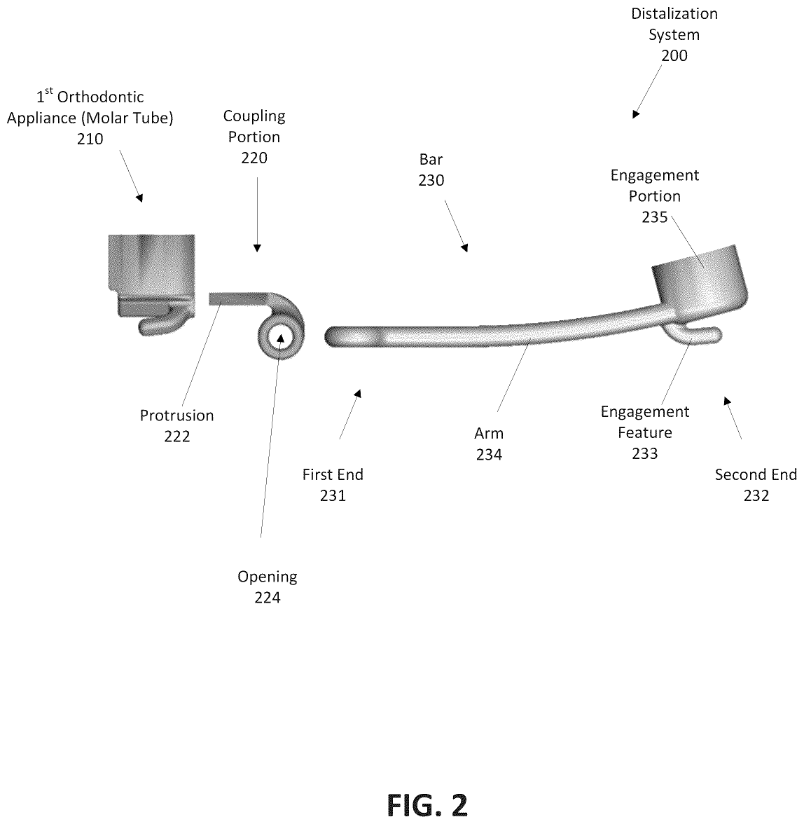

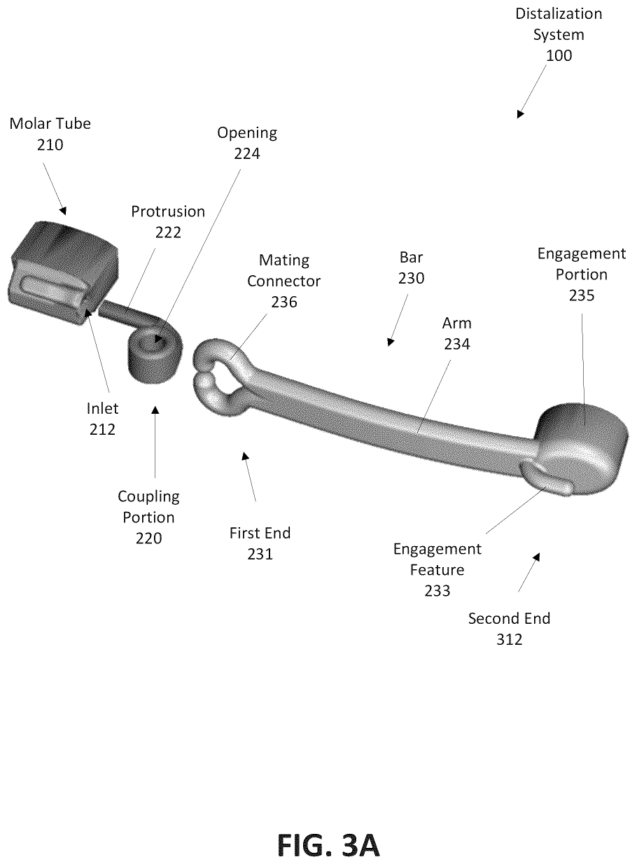

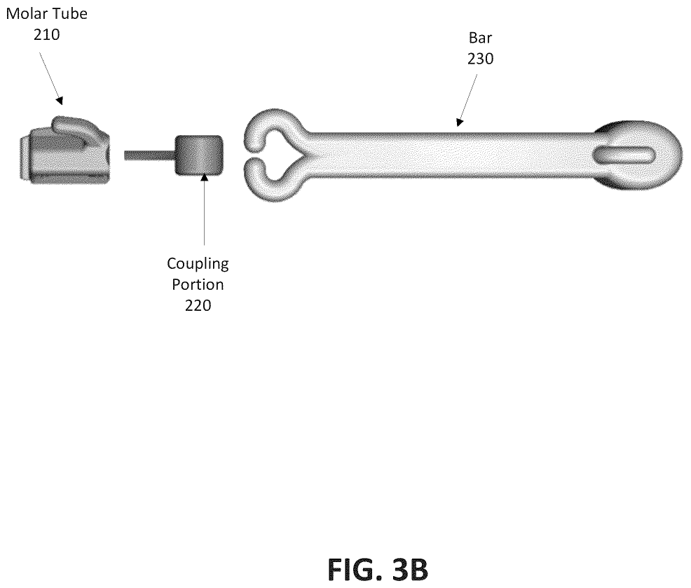

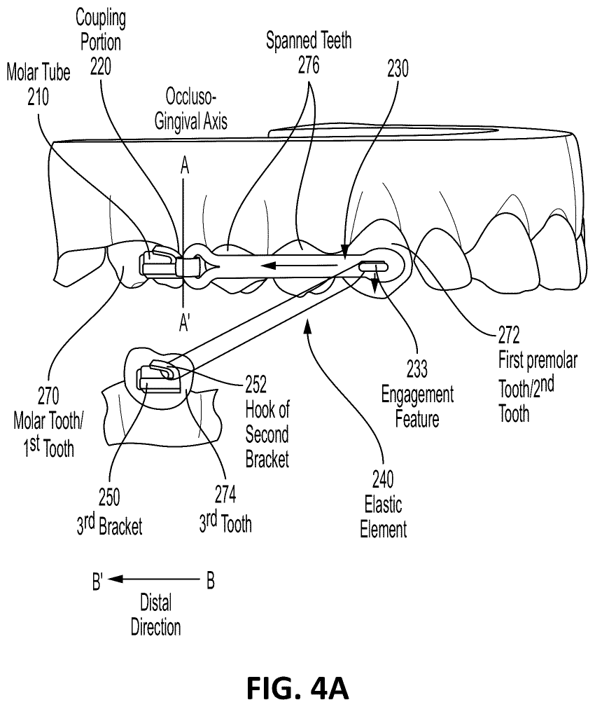

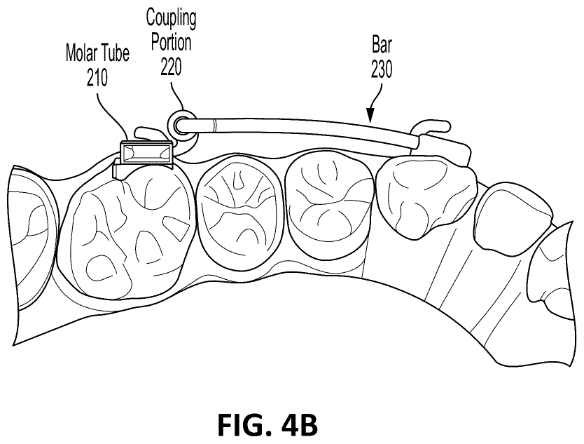

FIGS. 2-4B show an exemplary distalization system 200 according to aspects of the present disclosure. FIG. 2 shows a plan view of the distalization system 200 according to aspects of the present disclosure. FIG. 3A shows a perspective view of the distalization system 200 of FIG. 2 according to aspects of the present disclosure. FIG. 3B shows a side view of the distalization system 200 of FIG. 2 according to aspects of the present disclosure. FIG. 4A shows a perspective view of the distalization system 200 of FIG. 2 placed within a patient's mouth according to aspects of the present disclosure. FIG. 4B shows a plan view of the distalization system 200 of FIG. 2 placed within a patient's mouth according to aspects of the present disclosure.

Distalization system 200 may include an orthodontic appliance 210 configured to be attached to the surface of a patient's tooth. The orthodontic appliance may be a bracket, buccal tube, caplin hook, or any other orthodontic appliance. The orthodontic appliance 210 is attached to a first tooth 270 which may be any tooth including the molar and premolar teeth. In this exemplary embodiment, the orthodontic appliance 210 is a buccal tube disposed on the maxillary second molar. The buccal tube may include at least one inlet. As illustrated in FIGS. 2-4B, the buccal tube has one inlet 212 configured to receive an arch wire. However, in some embodiments, orthodontic appliance 210 may be a double tube having two inlets or a triple tube having three inlets. The at least one inlet 212 may also be configured to receive a coupling portion 220 such that a bar 230 is engaged with the buccal tube for distalization of the teeth. In an alternative embodiment, the first orthodontic appliance 210 may be a bracket having an arch wire slot. Coupling portion 220 may then be received by the arch wire slot of the bracket. The coupling portion 220 may be fastened to the bracket via a steel ligature, elastic ligatures, ligatures of self-ligating brackets, or similar.

The coupling portion 220 may be configured to couple the buccal tube 210 to the bar 230. In some embodiments, the coupling portion 220 may be configured to rotationally couple the buccal tube 210 to the bar 230 to allow for rotation about the occluso-gingival axis A-A′. Coupling portion 220 may include a protrusion 222 and an opening 224. Protrusion 222 may be configured to be inserted into inlet 212 of the buccal tube 210. Opening 224 may be configured to engage with mating connector 236 disposed at a first end 231 of bar 230. In some embodiments, opening 224 may be aligned along the occluso-gingival axis A-A′ to allow for rotation about the occluso-gingival axis A-A′. Mating connector 236 may include at least one protrusion configured to protrude into, and thus be received by, the opening 224 of the coupling portion.

In an exemplary embodiment, the bar 230 may include two protrusions as shown in FIG. 3A, of which a first protrusion may be received by a first end of the opening 224 and a second protrusion may be received by the second end of the opening 224. However, it should be appreciated that the techniques are not so limited. For example, other mating techniques can be used between the coupling portion 220 and the bar 230 (e.g., hinges, pins, a single protrusion, etc.). As another example, while the coupling portion 220 is shown as a separate component from the bar 230, in some embodiments the coupling portion may be a part of the bar 230. For example, the bar 230 can be manufactured to form the coupling portion at the first end 231 of the bar 230, such that the coupling portion is part of the bar 230. For example, the bar 230 can include a score or other deformation along the occluso-gingival axis (instead of the opening 224 and mating connector 236) towards the first end 231 to create the coupling portion at the end of the bar 230. The score or other deformation may allow for deformation of the end of the bar 230 (the coupling portion), which in turn may allow for rotation about the occluso-gingival axis. In some embodiments, the coupling portion 220 may be a separate element from bar 230. In alternative embodiments, the coupling portion 220 and the bar 230 may be a monolithic element. In some embodiments, the coupling portion 220 and bar 230 may be made of a ceramic, plastic, or metal. In some embodiments, the coupling portion 220 and the bar 230 may be made of a same or different material.

FIGS. 2-4B show the use of the protrusion 222 to be inserted into the inlet 212 of the molar tube 210. However, it should be appreciated that the techniques are not so limited. For example, the coupling portion 220 may be configured to mate with other orthodontic appliances, such as an orthodontic bracket. Accordingly, the coupling portion 220 may include a different physical configuration that is designed to mate with an orthodontic bracket (e.g., by snapping over the orthodontic bracket, by fitting within an arch wire slot of the bracket, etc.). As another example, the coupling portion 220 can be configured to mate with the tube using other physical configurations (e.g., by snapping over the tube, etc.).

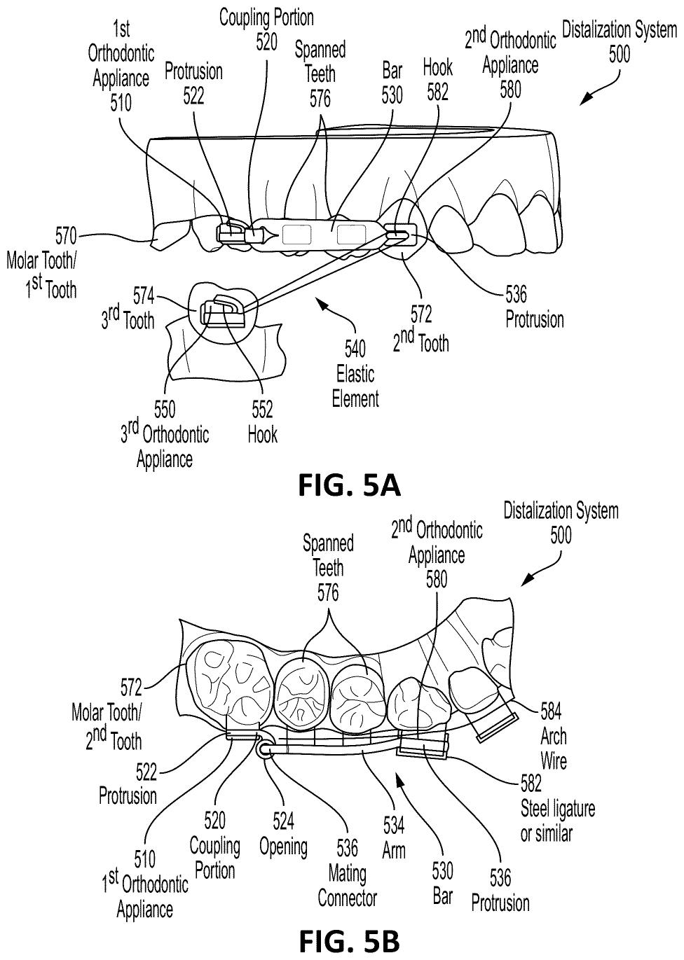

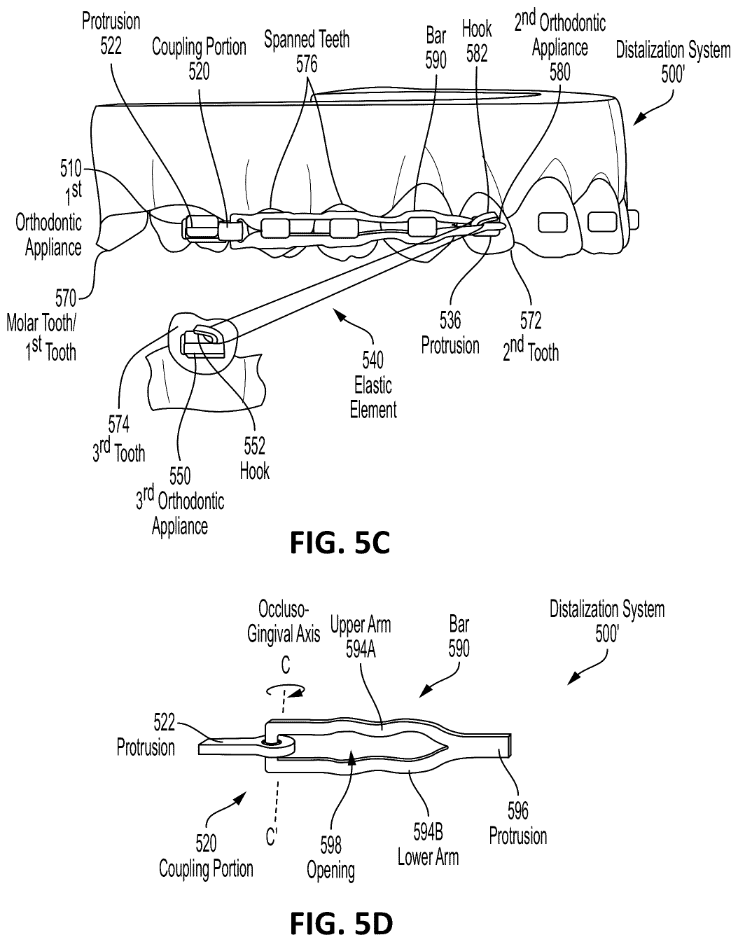

The first end 231 of bar 230 may be connected to a second end 232 of bar 230 via an arm 234. The arm 234 may be configured to span at least one tooth 276 situated between a first tooth 270 attached to the buccal tube 210 and a second tooth 272 attached to the attachment portion 235 of the bar 230. The spanned teeth 276 may be any teeth including at least one of the molar, premolar, and canine teeth. In this exemplary embodiment, the spanned teeth may be the maxillary first molar and the maxillary second premolar. The arm 234 may be substantially shaped to follow the labial or lingual surfaces of the at least one tooth in which the arm spans. In some embodiments, the arm 234 may be shaped so that the arm 234 can be disposed over at least one bracket attached to the at least one tooth over which the arm spans (e.g., as shown in FIG. 5B). In some embodiments, the arm 234 may be disposed behind the brackets of the at least one tooth in which the arm spans (e.g., as shown in FIG. 5C).

In some embodiments, bar 230 may include a second end 232 configured to engage with a second tooth 272 via an engagement portion 235. Engagement portion 235 may be configured to engage with a second bracket attached to a second tooth 272. In some embodiments, engagement portion 235 may be configured to be placed over a bracket attached to the second tooth 272. In other embodiments, engagement portion 235 may be configured to be directly bonded to the second tooth 272 or may be configured to be attached to a bonding pad for attachment to the second tooth 272. Second tooth 272 may be any tooth including a molar, premolar, or canine tooth. In this exemplary embodiment, the second tooth 272 may be the maxillary first premolar.

Second end 232 may also include an engagement feature 233 configured to receive a first end of elastic element 240. In some embodiments, engagement feature 233 is a hook configured to suspend elastic element 240 (e.g., a rubber band) at a first end. Elastic element 240 may have a second end configured to engage with an engagement feature 252 of a third orthodontic appliance 250. In some embodiments, the third orthodontic appliance 250 may be a buccal tube or a caplin hook. The third orthodontic appliance 250 may be attached to a third tooth 274. The third tooth 274 may be any tooth including a molar or premolar. In some embodiments, the third tooth 274 is a mandibular second molar. In some embodiments, engagement feature 252 is a hook configured to suspend elastic element 240 (e.g., a rubber band) at a second end. The elastic element 240 may be configured to apply a force distally B-B′. The distal force on the bar 230 may in turn apply a distal force on first tooth 270, second tooth 272, and the at least one tooth in which the arm spans 276. This may allow the first tooth 270, second tooth 272, and the at least one tooth in which the arm spans 276 to move in the distal direction B-B′ to create space in the dental arch. The distal force applied on bar 230 may also be translated into a rotational force via coupling portion 220. Rotational force may be applied to second tooth 272 such that second tooth 272 rotates about the occluso-gingival axis A-A′ to create space in the dental arch.

FIGS. 5A-7B show various additional exemplary distalization systems according to aspects of the present disclosure. Distalization systems of FIGS. 5A-7B may be configured to distalize the teeth as to create space in the dental arch, as discussed herein. In some embodiments, distalization systems of FIGS. 5A-7B may be used in conjunction with other dental appliances used for a treatment of the malocclusion. As such, treatment using the distalization system and treatment using other dental appliances may be implemented concurrently.

FIGS. 5A-B show another distalization system 500 according to aspects of the present disclosure. Distalization system 500 may include a first orthodontic appliance 510 attached to the surface of a patient's tooth. The first orthodontic appliance 510 may be a bracket, buccal tube, caplin hook, etc. The orthodontic appliance 510 is attached to a first tooth 570 which may be any tooth including the molar and premolar teeth. In this exemplary embodiment, the orthodontic appliance 510 is a buccal tube disposed on the maxillary second molar. The buccal tube may include at least one inlet. As illustrated in FIG. 5A, the buccal tube has one inlet configured to receive an arch wire. The at least one inlet may receive a coupling portion 520 such that a bar 530 is engaged with the buccal tube for distalization of the teeth. However, this is for exemplary purposes only since the orthodontic appliance 510 can have other configurations, such as a double tube having two inlets or a triple tube having three inlets. Accordingly, the coupling portion 520 may have multiple protrusions. In some embodiments, for tubes having more than one inlet, one inlet may be configured to receive an arch wire and at least one inlet may be configured to receive the coupling portion 520. In some embodiments, the first orthodontic appliance 510 may be a different appliance other than a tube, such as a bracket having an arch wire slot. Protrusion 522 may then be received by the arch wire slot of the bracket. The protrusion 522 may be fastened to the bracket via a steel ligature, elastic ligatures, ligatures of self-ligating brackets, or similar. In some embodiments, the slot may receive both the arch wire 584 and the protrusion 522 of the coupling portion 520 concurrently to perform treatment using both the arch wire and the distalizing bar 530. In some embodiments, the coupling portion may have a different physical configuration for mating with the orthodontic appliance 510 than that shown in FIGS. 5A-5B, as described herein.

The coupling portion 520 may be configured to couple the buccal tube 510 to the bar 530. In some embodiments, the coupling portion 520 may be configured to rotationally couple the buccal tube 510 to the bar 530 to allow for rotation in the occluso-gingival axis. Coupling portion 520 may include have a protrusion 522 and an opening 524. Protrusion 522 may be configured to be inserted into inlet of the buccal tube 510. Opening 524 may be configured to engage with mating connector 536 disposed at a first end of bar 530. In some embodiments, opening 524 may be aligned along the occluso-gingival axis to allow for rotation about the occluso-gingival axis. Mating connector 536 may include at least one protrusion configured to be received by the opening 524 of the coupling portion.

In an exemplary embodiment, the bar 530 may include two protrusions, of which a first protrusion may be received by a first end of the opening 524 and a second protrusion may be received by the second end of the opening 524. However, it should be appreciated that the techniques are not so limited. For example, other mating techniques can be used between the coupling portion 520 and the bar 530 (e.g., hinges, pins, a single protrusion, etc.). As another example, while the coupling portion 520 is shown as a separate component from the bar 530, in some embodiments the coupling portion may be a part of the bar 530. For example, the bar 530 can be manufactured to form the coupling portion at the first end of the bar 530, such that the coupling portion is part of the bar 530. For example, the bar 530 can include a score or other deformation along the occluso-gingival axis (instead of the opening 524 and mating connector 536) towards the first end to create the coupling portion at the end of the bar 530. The score or other deformation may allow for deformation of the end of the bar 530 (the coupling portion), which in turn may allow for rotation about the occluso-gingival axis. In some embodiments, the coupling portion 520 may be a separate element from bar 530. In alternative embodiments, the coupling portion 520 and the bar 530 may be a monolithic element. In some embodiments, the coupling portion 520 and bar 530 may be made of a ceramic, plastic, or metal. In some embodiments, the coupling portion 520 and the bar 530 may be made of a same or different material.

FIGS. 5A-5B show the use of the protrusion 522 to be inserted into the inlet of the molar tube 510. However, it should be appreciated that the techniques are not so limited. For example, the coupling portion 520 may be configured to mate with other orthodontic appliances, such as an orthodontic bracket. Accordingly, the coupling portion 520 may include a different physical configuration that is designed to mate with an orthodontic bracket (e.g., by snapping over the orthodontic bracket, by fitting within an arch wire slot of the bracket, etc.). As another example, the coupling portion 520 can be configured to mate with the tube using other physical configurations (e.g., by snapping over the tube, etc.).

The first end of bar 530 may be connected to a second end of bar 530 via an arm 534. The arm 534 may be configured to span the at least one tooth 576 situated between a first tooth 570 attached to the buccal tube 510 and a second tooth 572 attached to the attachment portion 535 of the bar 530. The spanned teeth 576 may be any teeth including at least one of the molar, premolar, and canine teeth. In this exemplary embodiment, the spanned teeth 576 may be the first molar and the second premolar. The arm 534 may be substantially shaped to follow the labial or lingual surfaces of the at least one tooth in which the arm spans. In some embodiments, the arm 534 may be shaped so that the arm 534 can be disposed over at least one bracket attached to the at least one tooth in which the arm spans. In some embodiments, the arm 534 may be disposed behind the brackets of the at least one tooth in which the arm spans.

In some embodiments, bar 530 may include a second end configured to engage with a second tooth 572 via a protrusion 536. Protrusion 536 may be configured to engage with a second orthodontic appliance 580 attached to a second tooth 572. The second orthodontic appliance 580 may be, for example, a bracket including a slot configured to receive an arch wire. Protrusion 536 may then be received by the arch wire slot of the bracket. The protrusion 536 may be fastened to the bracket via a steel ligature, elastic ligatures, ligatures of self-ligating brackets, or similar. In some embodiments, the slot may receive both the arch wire 584 and the protrusion 536 of bar 530 concurrently to perform treatment using both the arch wire and the distalizing bar 530.

Second orthodontic appliance may also include an engagement feature 582 configured to receive a first end of elastic element 540. In some embodiments, engagement feature 582 is a hook configured to suspend elastic element 540 (e.g., a rubber band) at a first end. In some embodiments, the third orthodontic appliance 550 may be a buccal tube or a caplin hook. The third orthodontic appliance 550 may be attached to a third tooth 574. The third tooth 574 may be any tooth including a molar or premolar. In some embodiments, the third tooth 574 is a mandibular second molar. Elastic element 540 may have a second end configured to engage with an engagement feature 552 of the third orthodontic appliance 550. In some embodiments, engagement feature 552 is a hook configured to suspend elastic element 540 (e.g., a rubber band) at a second end. The elastic element 540 may be configured to apply a distal force on the second orthodontic appliance 580. The second orthodontic appliance 580 may apply a distal force on bar 530 which in turn may apply a distal force on first tooth 570, second tooth 572, and the at least one tooth in which the arm spans. This may allow the first tooth 570, second tooth 572, and the at least one tooth in which the arm spans to move in the distal direction to create space in the dental arch. The distal force applied on bar may also be translated into a rotational force via coupling portion 520. Rotational force may be applied to second tooth 572 such that second tooth 572 rotates about the occluso-gingival axis to create space in the dental arch.

FIG. 5C-D show a third exemplary distalization system 500′ according to aspects of the present disclosure. In some embodiments, distalization system 500′ may be used in conjunction with other dental appliances (e.g., brackets, arch wires) used for a treatment of the malocclusion. In some embodiments, distalization system 500′ may include similar features as distalization system 500, but distalization system 500′ may have a bar 590 that may be disposed behind the brackets of spanned teeth 576. The bar 590 may include an upper arm 594A, a lower arm 594B, and an opening 598 disposed between the upper arm 594A and the lower arm 594B. The opening 598 may be configured to receive brackets of spanned teeth 576 such that the upper arm 594A is disposed behind an upper portion of the brackets and 594B is disposed behind a lower portion of the brackets. Disposing the bar behind the brackets of the spanned teeth may provide a more comfortable treatment for the patient. In some embodiments, the upper arm 594A and the lower arm 594B may be substantially shaped to follow the labial or lingual surfaces of the at least one tooth in which the arm spans.

Bar 590 may have a first end configured to engage with a coupling portion. In some embodiments, the coupling portion may be similar to the coupling portion 520 as described above. The first end of bar 590 may include a mating connector 536 configured to be received by the opening 524 of the coupling portion 520. In an exemplary embodiment, the bar 590 may include two protrusions, of which a first protrusion may be received by a first end of the opening 524 and a second protrusion may be received by the second end of the opening 524. However, it should be appreciated that the techniques are not so limited. For example, other mating techniques can be used between the coupling portion 520 and the bar 590 (e.g., hinges, pins, a single protrusion, etc.). As another example, while the coupling portion 520 is shown as a separate component from the bar 530, in some embodiments the coupling portion may be a part of the bar 530. For example, the bar 530 can be manufactured to form the coupling portion at the first end of the bar 590, such that the coupling portion is part of the bar 590. For example, the bar 590 can include a score or other deformation along the occluso-gingival axis (instead of the opening 524 and mating connector) towards the first end to create the coupling portion at the end of the bar 590. The score or other deformation may allow for deformation of the end of the bar 590 (the coupling portion), which in turn may allow for rotation about the occluso-gingival axis. In some embodiments, the coupling portion 520 may be a separate element from bar 590. In alternative embodiments, the coupling portion 520 and the bar 590 may be a monolithic element. In some embodiments, the coupling portion 520 and bar 590 may be made of a ceramic, plastic, or metal. In some embodiments, the coupling portion 520 and the bar 590 may be made of a same or different material.

The upper arm 594A and the lower arm 594B of bar 590 may join to form protrusion 596 at a second end of bar 590. Protrusion 596 may be configured to engage with an orthodontic appliance. In some embodiments, the protrusion 596 may be configured to engage with the second orthodontic appliance 580, as described above. The second orthodontic appliance 580 may be attached to a second tooth 572. The second orthodontic appliance 580 may be, for example, a bracket including a slot configured to receive an arch wire. Protrusion 596 may then be received by the arch wire slot of the bracket. The protrusion 596 may be fastened to the bracket via a steel ligature, elastic ligatures, ligatures of self-ligating brackets, or similar. In some embodiments, the slot may receive both the arch wire 584 and the protrusion 596 of bar 590 concurrently to perform treatment using both the arch wire and the distalizing bar 590.

In some embodiments, distalization force may be applied to the second orthodontic appliance 580 as similarly described above. Second orthodontic appliance may also include an engagement feature 582 configured to receive a first end of elastic element 540. In some embodiments, engagement feature 582 is a hook configured to suspend elastic element 540 (e.g., a rubber band) at a first end. In some embodiments, the third orthodontic appliance 550 may be a buccal tube or a caplin hook. The third orthodontic appliance 550 may be attached to a third tooth 574. The third tooth 574 may be any tooth including a molar or premolar. In some embodiments, the third tooth 574 is a mandibular second molar. Elastic element 540 may have a second end configured to engage with an engagement feature 552 of the third orthodontic appliance 550. In some embodiments, engagement feature 552 is a hook configured to suspend elastic element 540 (e.g., a rubber band) at a second end. The elastic element 540 may be configured to apply a distal force on the second orthodontic appliance 580. The second orthodontic appliance 580 may apply a distal force on bar 590 which in turn may apply a distal force on first tooth 570, second tooth 572, and the at least one tooth in which the arm spans. This may allow the first tooth 570, second tooth 572, and the at least one tooth in which the arm spans to move in the distal direction to create space in the dental arch. The distal force applied on bar 590 may also be translated into a rotational force via coupling portion 520. Rotational force may be applied to second tooth 572 such that second tooth 572 rotates about the occluso-gingival axis C-C′ to create space in the dental arch.

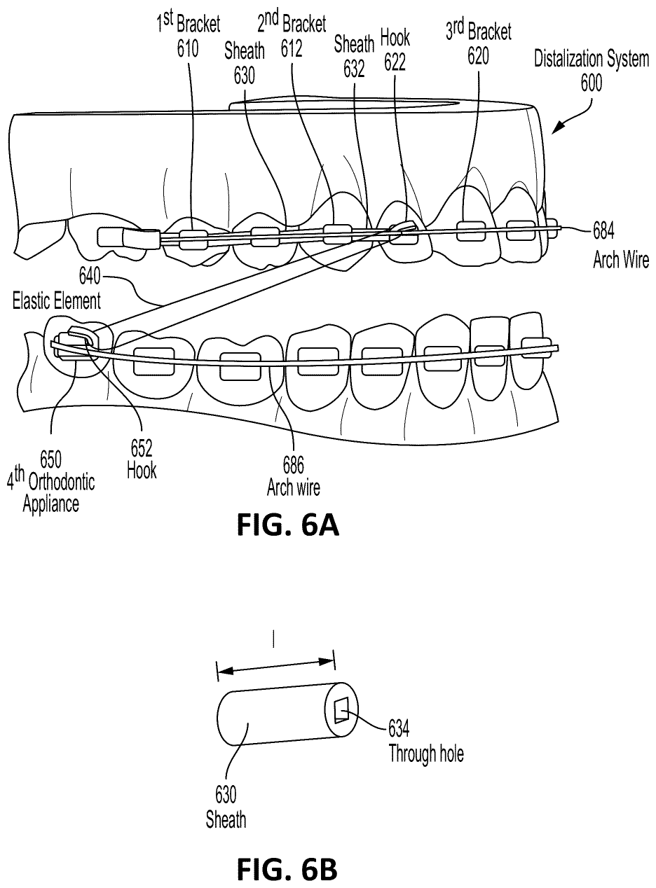

FIG. 6A-B show a fourth exemplary distalization system 600 according to aspects of the present disclosure. Distalization system 600 may include orthodontic appliances attached the patient's teeth. In some embodiments, the orthodontic appliances are brackets and/or buccal tubes that have a slot for receiving an arch wire. The orthodontic appliances of distalization system 600 may include a first bracket 610, a second bracket 612, and a third bracket 620. The orthodontic brackets 610, 612, and 620 may be disposed on any tooth including molar, premolar, and canine teeth. In this exemplary embodiment, the orthodontic brackets 610, 612, and 620 are disposed on the maxillary first molar, maxillary second premolar, and the maxillary first premolar, respectively.

The distalization system 600 may also include a sheath configured to surround a portion of the arch wire disposed between adjacent orthodontic appliances (e.g., brackets and/or tubes). The sheath may also be configured to transmit a distalizing force between brackets, as discussed in more detail herein. A first sheath 630 may surround a portion of arch wire disposed between the first bracket 610 and the second bracket 612. A second sheath 632 may surround a portion of the arch wire disposed between the second bracket 612 and the third bracket 620. As seen in FIG. 6B, exemplary sheath 630 may have a through hole 634 that spans the length l of sheath 630. The through hole 634 may be configured to receive arch wire 684. Length l of sheath 630 may span or approximately span the gap between adjacent brackets, first bracket 610 and second bracket 612. In some embodiments, sheath 630 may have a same or different length than sheath 632. In some embodiments, length of sheaths 630, 632 may be customized to based on the patient's teeth or the bracket positioning.

To perform distalization, a distalizing force may be applied to the third orthodontic bracket 620 via use of an elastic element 640. Third orthodontic bracket 620 may include an engagement feature 622. In some embodiments, the engagement feature is a hook configured to suspend element 640 (e.g., a rubber band) at a first end. Elastic element 640 may have a second end configured to engage with an engagement feature 652 of a fourth orthodontic appliance 650. In some embodiments, the fourth orthodontic appliance 650 may be a buccal tube or a caplin hook. The fourth orthodontic appliance 650 may be attached to any tooth including a molar or premolar. In some embodiments, the fourth orthodontic appliance 650 is attached to the mandibular second molar. In some embodiments, the fourth orthodontic appliance 650 may be a buccal tube or bracket configured to receive arch wire 686. In some embodiments, engagement feature 652 is a hook configured to suspend elastic element 640 (e.g., a rubber band) at a second end.

The elastic element 640 may be configured to apply a distal force on the third orthodontic appliance 620. The distal force on the third orthodontic appliance 620 may then apply a distal force on sheath 632. Sheath 632 may then be configured to transmit the distal force to the 2^{nd} orthodontic appliance 612, which may then apply a distal force to sheath 630. Sheath 630 may be configured to transmit the distal force to the first orthodontic appliance 610. The transmission of the distal force via the sheaths 630, 632 may allow for the distalization of at least the teeth attached to the first 610, second 612, and third 620 brackets. In some embodiments, sheath 630, 632 may be made of a ceramic, plastic or metal that may permit the transmission of the distal force. In some embodiments, sheath 630 may be formed of a same material or different material that may have different mechanical properties than sheath 632. In some embodiments, the sheaths 630, 632 may be custom designed in length and material property based on the patient's teeth or bracket positioning.

Sheath 630, 632 may be applied to the distalization system 600 using a variety of methods. For example, the arch wire may be inserted into the sheaths during insertion of arch wire into the bracket slots. When arch wire 684 has been received by third orthodontic appliance 620, arch wire 684 may be inserted into the sheath 632. Once the sheath 632 is on the arch wire 684, the arch wire 684 may then be received by second orthodontic appliance 612. Sheath 630 may then be placed onto arch wire 684 and then arch wire 684 may be received by first orthodontic appliance 610. In another embodiment, sheaths may include a slit along the length of the sheath. This may allow the sheath to be easily mounted around the arch wire after installation of the arch wire. This may also allow the sheath to be easily removed without removing arch wire 684.

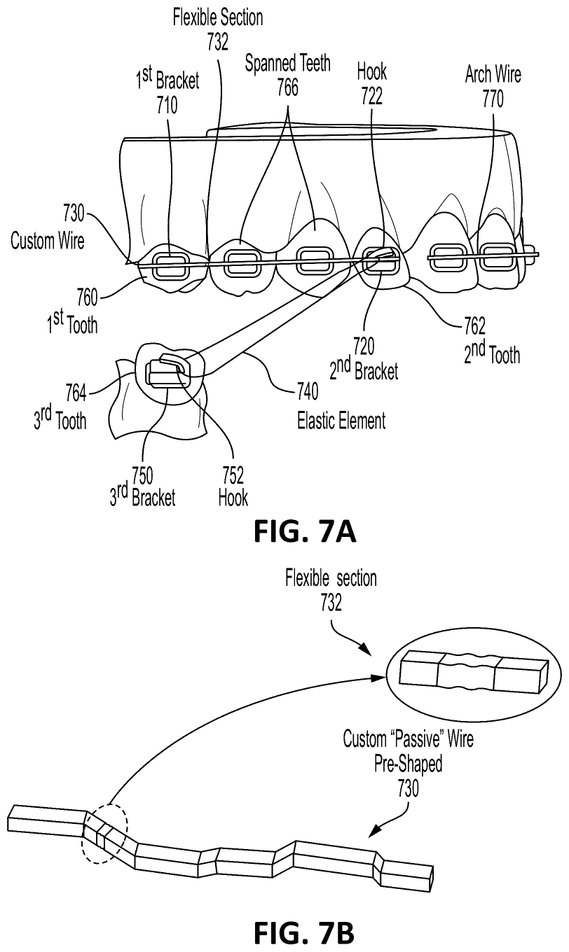

FIG. 7A-B show a fifth exemplary distalization system 700 according to aspects of the present disclosure. Distalization system 700 may include orthodontic appliances attached to the patient's teeth. The orthodontic appliances of distalization system 700 may include a molar tube 710 and brackets 720, 750 which have slots to receive an arch wire. The orthodontic appliances 760, 720, and 750 may be disposed on any tooth including molar, premolar, and canine teeth.

The distalization system 700 may include a custom wire 730 configured to be received by orthodontic appliances 760, 762, and 766. In some embodiments, custom wire 730 may be configured to engage with appliances attached to the teeth that are to be distalized. In some embodiments, the custom wire 730 may also be configured to engage with other appliances attached to teeth that are not being distalized. In some embodiments, custom wire 730 may be received by slots of brackets and or buccal tubes. The custom wire 730 may be fastened to the bracket via a steel ligature, elastic ligatures, ligatures of self-ligating brackets, or similar. Custom wire 730 may be pre-shaped to allow for custom wire 730 to transmit a distal force between brackets.

To perform distalization, a distalizing force may be applied to the second orthodontic bracket 720 via use of an elastic element 740. Second orthodontic bracket 720 may include an engagement feature 722. In some embodiments, the engagement feature is a hook configured to suspend element 740 (e.g., a rubber band) at a first end. Elastic element 740 may have a second end configured to engage with an engagement feature 752 of a third orthodontic appliance 750. In some embodiments, the third orthodontic appliance 750 may be a buccal tube or caplin hook. The third orthodontic appliance 750 may be attached to any tooth including a molar or premolar. In some embodiments, the third orthodontic appliance 750 is attached to the mandibular second molar. In some embodiments, engagement feature 752 is a hook configured to suspend elastic element 740 (e.g., a rubber band) at a second end.

The elastic element 740 may be configured to apply a distal force on the second orthodontic appliance 720. The distal force on the second orthodontic appliance 720 may then apply a distal force on custom wire 730. Custom 730 may then be configured to transmit the distal force to the brackets attached to teeth 760 and 766. The transmission of the distal force via the sheaths 730, 732 may allow for the distalization of at least the teeth 760, 762, and 766. Custom wire 730 may include a flexible section 732. In some embodiments, the flexible section may be positioned between the 1st bracket and an adjacent bracket of the spanned teeth 766. The flexible section 732 may convert the distal force applied on the custom wire 730 into a rotation force about the occulo-gingival axis. The rotational force may then rotate first tooth 760. In some embodiments, custom wire 730 may be made of a ceramic, plastic, or metal that may permit the transmission of the distal force. In some embodiments, the custom wire 730 may be custom designed based on the patient's teeth or bracket positioning.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

All definitions, as defined and used herein, should be understood to control over dictionary definitions, definitions in documents incorporated by reference, and/or ordinary meanings of the defined terms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The indefinite articles “a” and “an,” as used herein in the specification and in the claims, unless clearly indicated to the contrary, should be understood to mean “at least one.”

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “equal” or “the same” in reference to two values (e.g., distances, widths, etc.) means that two values are the same within manufacturing tolerances. Thus, two values being equal, or the same, may mean that the two values are different from one another by ±5%.

The terms “approximately” and “about” if used herein may be construed to mean within ±20% of a target value in some embodiments, within ±10% of a target value in some embodiments, within ±5% of a target value in some embodiments, and within ±2% of a target value in some embodiments. The terms “approximately” and “about” may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

While various embodiments have been described, it will be apparent to those of ordinary skill in the art that many more embodiments and implementations are possible. Accordingly, the embodiments described herein are examples, not the only possible embodiments and implementations. Furthermore, the advantages described above are not necessarily the only advantages, and it is not necessarily expected that all of the described advantages will be achieved with every embodiment.

Various aspects are described in this disclosure, which include, but are not limited to, the following aspects.

1. A dental appliance comprising: a bar comprising a first end and a second end, wherein the first end is configured to engage with a first tooth; and a coupling portion at the second end of the bar configured to engage with an orthodontic bracket bonded to a second tooth, wherein the coupling portion is configured to rotate about an axis.

2. The dental appliance of aspect 1 wherein the first end is configured to engage with the first tooth by engaging with a second bracket bonded to the first tooth.

3. The dental appliance of any one of aspects 1-2 wherein the coupling portion comprises a flexible portion configured to rotate about the axis.

4. The dental appliance of any one of aspects 1-3 wherein the coupling portion comprises a mating connection configured to connect to a bracket attachment that engages with the orthodontic bracket bonded to the second tooth.

5. The dental appliance of aspect 4 wherein: the orthodontic bracket is a tube with an inlet configured to receive an end of an arch wire; and the bracket attachment comprises a protrusion that fits within the inlet to engage the bracket attachment with the orthodontic bracket.

6. The dental appliance of any one of aspects 1-5, wherein the bar is a distalizer.

7. The dental appliance of aspect 6, wherein: the second tooth comprises a molar; and the bar is configured to distalize the molar.

8. The dental appliance of any one of aspects 1-7, wherein: the first end of the bar comprises an engagement feature configured to engage with an elastic element; and the elastic element applies a distal force on the bar.

9. The dental appliance of aspect 8, wherein a first end of the elastic element is configured to engage with the engagement feature and a second end of the engagement feature is configured to engage with a third orthodontic bracket attached to a mandibular tooth.

10. The dental appliance of any one of aspects 1-9, wherein the coupling portion is configured to rotate about the occluso-gingival axis.

11. The dental appliance of any one of aspects 1-10, wherein the first tooth is one of a canine and a premolar.

12. A method of treating a patient using a dental appliance comprising: installing the dental appliance, wherein the dental appliance comprises: a bar comprising a first end and a second end, wherein the first end is configured to engage with a first tooth; and a coupling portion at the second end of the bar configured to engage with an orthodontic bracket bonded to a second tooth, wherein the coupling portion is configured to rotate about an axis.

13. The method of aspect 12, wherein installing comprises: engaging the first end with the first tooth; and engaging the coupling portion with the orthodontic bracket bonded to the second tooth.

14. The method of any one of aspects 12-13, wherein the coupling portion comprises a mating connection configured to connect to a bracket attachment that engages with the orthodontic bracket bonded to the second tooth.

15. The method of any one of aspects 12-14, wherein: the first end of the bar comprises an engagement feature configured to engage with an elastic element; and the elastic element applies a distal force on the bar.

16. The method of any one of aspects 12-15, wherein the coupling portion is configured to rotate about the occluso-gingival axis.

17. A method of manufacturing a dental appliance comprising: manufacturing the dental appliance, wherein the dental appliance comprises: a bar comprising a first end and a second end, wherein the first end is configured to engage with a first tooth; and a coupling portion at the second end of the bar configured to engage with an orthodontic bracket bonded to a second tooth, wherein the coupling portion is configured to rotate about an axis.

18. The method of aspect 17, wherein the coupling portion comprises a mating connection configured to connect to a bracket attachment that engages with the orthodontic bracket bonded to the second tooth.

19. The method of any one of aspects 17-18, wherein: the first end of the bar comprises an engagement feature configured to engage with an elastic element; and the elastic element applies a distal force on the bar.

20. The method of any one of aspects 17-19, wherein the coupling portion is configured to rotate about the occluso-gingival axis.

21. A dental appliance comprising: a sheath comprising a through hole, wherein: the through hole is configured to receive an arch wire, the sheath is configured to transmit a distal force from a first orthodontic appliance to a second orthodontic appliance, and the first orthodontic appliance is adjacent to the second orthodontic appliance.

22. The dental appliance of aspect 21, wherein a length of the sheath is approximately a length of a gap between the first orthodontic appliance and the second orthodontic appliance.

23. The dental appliance of any one of aspects 21-22, wherein the first orthodontic appliance and the second orthodontic appliance are orthodontic brackets.

24. The dental appliance of any one of aspect 21-23, wherein: the first orthodontic appliance includes a hook, the hook is configured to suspend an elastic element, and the suspension of the elastic element causes a distal force to be applied on to the first orthodontic appliance.

25. A dental appliance comprising: a wire configured to: engage with a first orthodontic appliance attached to a first tooth, engage with a second orthodontic appliance attached to a second tooth, and transmit a distal force from the first orthodontic appliance to the second orthodontic appliance.

26. The dental appliance of aspect 25, wherein the wire comprises a flexible section disposed between the first and second orthodontic appliances.

27. The dental appliance of any one of aspects 25-26, wherein the flexible section is configured to convert the distal force to a rotational force, such that the rotational force rotates the second tooth about the occluso-gingival axis.

28. The dental appliance of any one of aspect 25-27, wherein the first and second orthodontic appliances are brackets.

1. A dental appliance, comprising:
a bar comprising a first end and a second end, wherein the first end is configured to engage with a first tooth; and
a coupling portion at the second end of the bar configured to engage with an orthodontic bracket bonded to a second tooth, wherein the coupling portion is configured to rotate about an axis.

2. The dental appliance of claim 1, wherein the first end is configured to engage with the first tooth by engaging with a second bracket bonded to the first tooth.

3. The dental appliance of claim 1, wherein the coupling portion comprises a flexible portion configured to rotate about the axis.

4. The dental appliance of claim 1, wherein the coupling portion comprises a mating connection configured to connect to a bracket attachment that engages with the orthodontic bracket bonded to the second tooth.

5. The dental appliance of claim 4, wherein:
the orthodontic bracket is a tube with an inlet configured to receive an end of an arch wire; and
the bracket attachment comprises a protrusion that fits within the inlet to engage the bracket attachment with the orthodontic bracket.

6. The dental appliance of claim 1, wherein the bar is a distalizer.

7. The dental appliance of claim 6, wherein:
the second tooth comprises a molar; and
the bar is configured to distalize the molar.

8. The dental appliance of claim 1, wherein:
the first end of the bar comprises an engagement feature configured to engage with an elastic element; and
the elastic element applies a distal force on the bar.

9. The dental appliance of claim 8, wherein a first end of the elastic element is configured to engage with the engagement feature and a second end of the engagement feature is configured to engage with a third orthodontic bracket attached to a mandibular tooth.

10. The dental appliance of claim 1, wherein the coupling portion is configured to rotate about the occluso-gingival axis.

11. The dental appliance of claim 1, wherein the first tooth is one of a canine and a premolar.

12. A method of treating a patient using a dental appliance, comprising:
installing the dental appliance, wherein the dental appliance comprises:
a bar comprising a first end and a second end, wherein the first end is configured to engage with a first tooth; and
a coupling portion at the second end of the bar configured to engage with an orthodontic bracket bonded to a second tooth, wherein the coupling portion is configured to rotate about an axis.

13. The method of claim 12, wherein installing comprises:
engaging the first end with the first tooth; and
engaging the coupling portion with the orthodontic bracket bonded to the second tooth.

14. The method of claim 12, wherein the coupling portion comprises a mating connection configured to connect to a bracket attachment that engages with the orthodontic bracket bonded to the second tooth.

15. The method of claim 12, wherein:
the first end of the bar comprises an engagement feature configured to engage with an elastic element; and
the elastic element applies a distal force on the bar.

16. The method of claim 12, wherein the coupling portion is configured to rotate about the occluso-gingival axis.

17. A method of manufacturing a dental appliance, comprising:
manufacturing the dental appliance, wherein the dental appliance comprises:
a bar comprising a first end and a second end, wherein the first end is configured to engage with a first tooth; and
a coupling portion at the second end of the bar configured to engage with an orthodontic bracket bonded to a second tooth, wherein the coupling portion is configured to rotate about an axis.

18. The method of claim 17, wherein the coupling portion comprises a mating connection configured to connect to a bracket attachment that engages with the orthodontic bracket bonded to the second tooth.

19. The method of claim 17, wherein:
the first end of the bar comprises an engagement feature configured to engage with an elastic element; and
the elastic element applies a distal force on the bar.

20. The method of claim 17, wherein the coupling portion is configured to rotate about the occluso-gingival axis.
